(19) United States
(12) Patent Application Publication
(10) Pub. No.: US 2011/0078974 A1
(43) Pub. Date: Apr. 7, 2011

(54) NAILESS, GLUELESS TRIM SYSTEM

(76) Inventor: Daniel Paul MITCHELL, Cedar Rapids, IA (US)

(21) Appl. No.: 12/778,686

(22) Filed: May 12, 2010

Related U.S. Application Data
(60) Provisional application No. 61/177,448, filed on May 12, 2009.

(51) Int. Cl. E04C 2/38; B32B 21/14; B32B 3/02

(52) U.S. Cl. 52/588.1; 428/142; 428/60; 428/141; 428/537.1

(57) ABSTRACT

A trim system consisting of a top layer of veneer, which is connected and recessed into a medium to high-density fiberboard or substitute (lower layer) therein. The baseboard has a unique tongue and groove system and results in an interlocking system that by its nature, secures the baseboard snugly to the wall without the need for after nailing or glues or adhesives. Because the ledger board system is recessed into the core of the exterior trim piece, the ledger board holds the exterior molding snugly without adding any additional offset or distance from the wall. The result is a form fitting molding that mounts tightly, flexibly and securely to most surfaces easily. Since the substrate is made of a process waste or by-product fiberboard or substitute, it is environmentally friendly and more structurally stable than most hardwoods. Structurally stable meaning that it doesn't shrink, twist, contract, or warp like most woods do. The system chosen is not only eco-friendly but the view layer can be glamorous to look at. The interlocking system can also be used to add additional utility and tight fit and appearance on solid woods or any other manufactured base system material, such as plastic, rubber, steel, etc. The removable block “smart wire” system, also affords for the concealment of wires and or cables simply and easily. The molding profiles and potential wood etc, combinations that can be produced are endless. The system should work well regardless of what decorative profile design is chosen.

### FIELD OF THE INVENTION

The present invention relates to a trim molding (system) product and design.

a) A structural design and uniqueness of this particular trim molding system is in the fact that the actual trim can be applied skillfully by almost anyone having neither nailed nor glued any portion of the installation. Furthermore, with attention to detail, proper measurement technique and simply following the easy to follow directions there is no need to have ever installed trim before to gain professional results. The trim molding system allows you trim just like the pros without the need for experience or expensive power tools.

It is fostered by an innovative track system that fastens securely to the wall through a series of supplied screws aligned 16″ on center with predrilled and measured countersunk holes. The fact that they are countersunk and the track is recessed (see FIG. 3) allows the screw and the track to have a flush and secure attachment to the wall that will last for many years to come. The unique system employs a recessed ledger that insures a superior fit to even less than perfect walls in most cases.

b) It is unique in design in that it is extremely user friendly. It can be made to fit by nearly anyone, anywhere with favorable results. But more importantly it can be made in so many finishes, and from so many substrates the design possibilities are endless. Finishes ranging but not limited to exotic real solid woods, wood veneers, plastics, metals, patterns etc. Each one easily installed and made economically and potentially even ecologically more affordable.

c) It is unique that it is neither limited by a color wheel or finishes and it is a natural for almost all settings from commercial to residential remodeling.

d) It is unique because home restoration and commercial trim renovations can be now done easily by unskilled labor, volunteers or friends. Anyone with a hand saw and a plastic miter box that can measure can install it easily. While most will cut with power equipment it is not required and therefore eliminates the need for advanced carpentry skill and or expensive equipment.

e) It is unique because the simple design allows for a measurement to be taken from the track itself once its cut to fit. After the track is attached around the perimeter of the room, the exterior trim is marked. The exterior trim piece is then measured several times for accuracy and is then easily cut to fit either blunt or in a mitered angle cut in the case of an inside or outside corner.

f) It is unique because the tongue of the track system, slides into a precise groove of the exterior trim and smoothly into a secured recessed double layer laminated track (see FIG. 1). A feature provided by the track is an assurance of a snug and secure fit to the wall without the use of external nails or glue. The track can be made of all types of materials but the concept is the same.

g) It is unique and complete. There is no need to nail or glue it into place. There should be no abrasions or damage to the exterior face of the trim after installation. So, when installed correctly; there is no need to wood putty, fill or repair holes and dents, marks, or stray nail damage caused by air or manual nailers and staplers etc. A cordless screwdriver is recommended but not required. And with the exception of a need to secure the unique track system with the screws provided, there is nothing else to buy. The track system could be applied albeit more difficult, simply with hand tools. The system would still allow superior results once in place.

h) It is unique because it trims in a way which allows some freedom as to minimizing future removal damage thereby making recycling moldings a snap vs. tear-out and the need for multiple molding replacement costs due to damage from tear-out.

i) It is unique because it is eco-friendly and environmentally responsible in nature. Because it can be made from wood or plastic by-products and veneers; it impacts the rainforests in a far more resource-conscience, responsible and economical way. This is meant to make it both affordable and resource friendly.

j) It is unique because it will lower cost of finish construction, restoration and allow repairing and replacing trim molding to be far less skill and labor intensive thereby allowing home and commercial repair and replacement to be a snap.

### BRIEF DESCRIPTION OF THE DRAWINGS

FIG. 1 is a side view of a construction according to the present invention.

FIG. 2 is a partially exploded sided view showing a composition structure for a construction according to the present invention.

FIG. 3 is an exterior view of a trim piece secured to a ledger board mounted to a wall.

FIG. 4 is another exterior view of a trim piece secured to a ledger board mounted to a wall.

FIG. 5 illustrates a smart wire notch which may be used in the construction according to the present invention.

FIG. 6 shows an example of a wood veneer which may be used in the construction according to the present invention.

FIG. 7 is a detailed side view of a beveled miter edge for the subject construction.

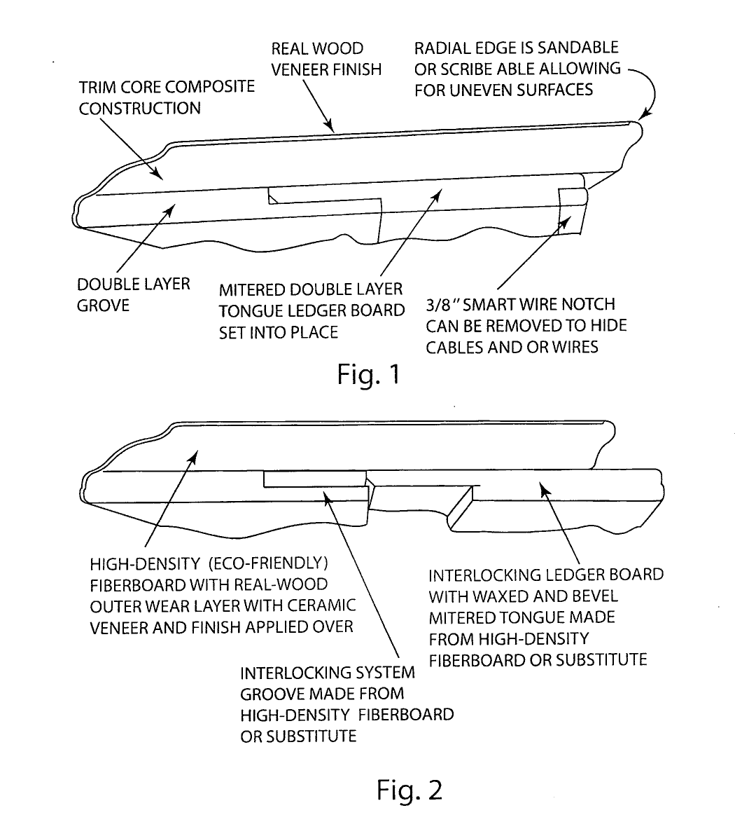

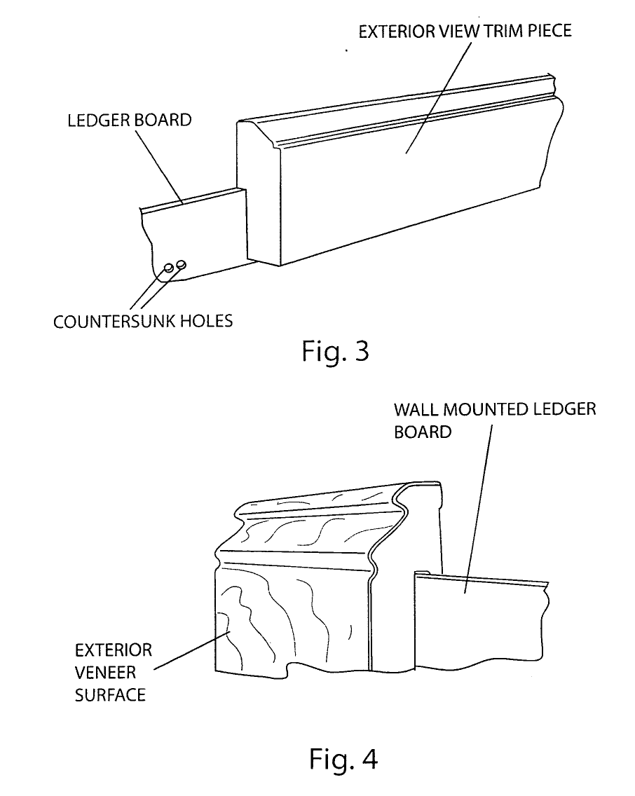

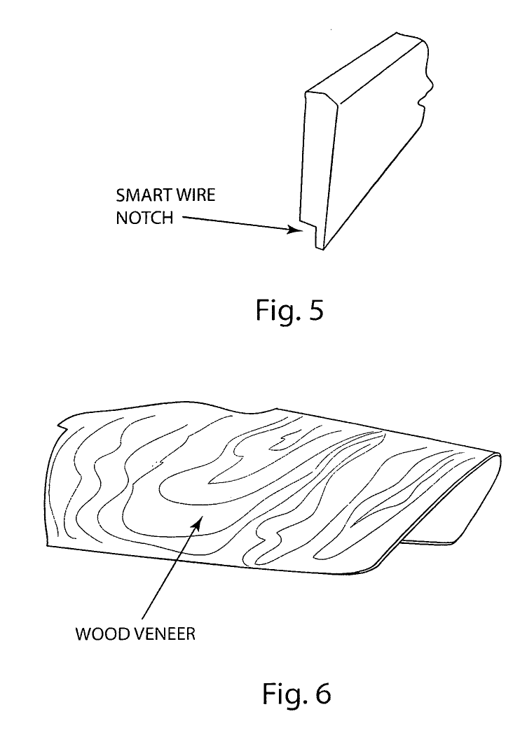

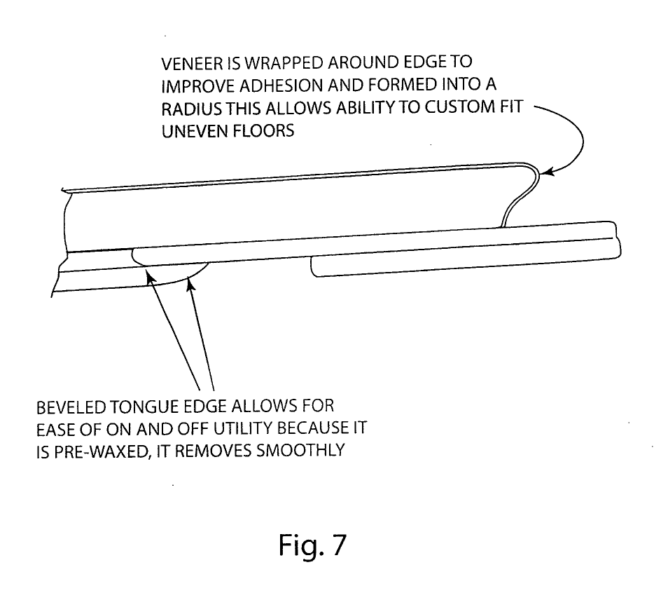

The track system: The track system is designed to slide into a groove that is cut in the back of the trim mold. It is positioned to interlock over 50% contact while allowing the base once applied to the track to be pulled tight (snug) to the wall. This unique recessed track provides the attachment to the wall therefore no nails or glue is ever required.

The material: Some material used but not limited to, is a medium to high-density (eco-friendly) fiberboard with a real wood veneer finish. This gives the appearance of a solid wood baseboard while not needlessly destroying more of the forests than necessary. Other materials such as recycled plastics may be used in the system to enable different looks and or finishes or even patterns.

Snug fit to wall; the innovative uniqueness of this track system is that it is a continuous board that follows closely the unevenness of the wall, thus minimizing any variations in the wall. Subsequently the trim will mold tightly to the substrate in almost all cases.

Custom Trim size: The size of the trim can vary in length or height based on the profile and materials to meet the needs of the individual user.

Hidden interlock system: The uniqueness of the interlocking system is that the lock (tongue and groove) will somewhat allow for both the depth and overall size of the base height chosen to be adjusted. The unique fastening track, i.e. the interlocking system is made up of several parts a) ledger board secured to the wall that fastens the b) outer groove of the trim to the track by joining to the core of the outside trim to the ledger board. What makes it so special is the way they are then held securely and snugly. Joined both top and bottom to the wall; two separate pieces are attached to each other and then secured flush to the wall. This unique system when installed correctly fits exactly into the back recess of the trim. This allows it to remain the same size (depth) as the overall size (thickness) of the molding against the wall when the tongue is fastened to the install board. When applied into the groove in the back of the trim, the two pieces join together snugly, allowing for one piece with the same uniform thickness as the outside trim piece itself.

Easy on and off design: The top of the track has a slight miter offset. This miter allows the top groove to slide better and smoothly over the bottom tongue with ease. Wax or a substitute is also applied to the bottom track to allow the pieces to slip together and apart easily. This aids in ease of removal if one would ever want, or need to remove the base for repainting, wallpapering, refinishing walls or floors, etc.

Material flexibility with improved adhesion: This product design utilizes a process in which, the veneer is wrapped over the (core) and attached to the top of the backside of the joined pieces and then wrapped around the bottom front of the board for improved adhesion to the core. Since the system albeit unique applies to a wide variety of substrates, other variations of plywood and or plastic or other materials may be utilized

Custom adaptability to uneven floors: The bottom surface of this unique trim has a profile design to compensate for uneven floors. By design, “the floor-type base trim only”, has a tapered to the front profile. With the profile being thicker at the back going down with a slight radius to a rounded thinner front edge; the bottom of the base can be easily scribed then cut or even marked and sanded without destroying the overall integrity, shape or structure. The trim can be cut or sanded to “custom fit” without experiencing much difficulty.

Concealing edge design: Another unique feature is an easily removable block approximately ⅜″ wide that may be removed from the bottom edge to allow for the hiding of wires and or cables. This design allows for low voltage speaker wires, Category 5 or similar diameter TV etc, cabling to be hidden from view simply and easily. Because any material can be utilized to create either the trim exterior or the ledger board, office and commercial networking is a simple slide on and off chore. This unique system allows for cleaner and more efficient use of space without the clutter of exposed cords and cables and it allows for continued scalability for growing offices or future equipment changes.

Eco-Friendliness: The body (core) of the baseboard can be made of medium to high-density fiberboard; thereby utilizing only a small fraction of the whole resource that otherwise would be required by a solid piece of wood. Because the core is produced from a wood by-product and far less wood resources or trees are required to produce than other solid solutions, it can be considered an efficient an environmentally friendly, and wiser trim system. While more efficient it is also noted that some substitute materials may still be used in the system to achieve certain individual tastes. These may be made of solid wood or other effects, finishes or designs as requested or desired.

### OBJECTIVES OF THE INVENTION

It is an objective of the present invention to provide an attractive looking product, which is engineered to provide a much more natural resource-efficient product than traditional solid wood products.

It is an objective of the present invention to utilize a unique tongue of the baseboard system which slides into the recessed groove of the double layer track and so the system affords superior wall contour control without utilizing brads, nails, or messy glues or adhesives, etc

It is an objective of the present invention to provide an improved engineered trim product able to be applied with little or no carpentry skill.

It is an objective of this invention to allow easily for uneven floor and wall situations and to provide easy no hassle concealment of wires and or cables.

1. A baseboard system comprised of: a first layer (wood veneer or substitute); and a unique recessed mounting track with a specially designed and mitered tongue that is secured to the wall via screw, double sided tape or hidden staple as desired.

2. A foundation of a trim system which slips directly into a unique recessed groove of the double layer laminated track in which a core or body of the trim is comprised of, but not limited to, a medium to high-density fiberboard or substitute.

3. A finish coating applied to the top surface of the veneer or substitute and final finished with a heat activated coating with ceramic particles in the coating in which a final finish will be saturated and re-coated with multiple layers of clear filler over the ceramic particles, thereby providing a long lasting hard surface, a unique wood grained appearance, and a more pleasant looking maintenance free exterior wear layer.

4. A tongue of the system as defined in claim 2 which goes into the uniquely recessed groove of the double layer laminated track, providing a snug fit to the wall without the need for additional adhesives or nails etc.

5. A system as defined in claim 1 which provides for less labor, less intensive cleanup and eliminates the need for wood fillers and or putty.

6. An exterior wherein a top veneer may be covered with a large and varying group of domestic and exotic hardwoods, some of which consist of, but are not limited to the following: white oak, Brazilian cherry, Burma teak, black walnut, Chinese red maple, African mahogany, kumaru, merbau, oaken, Asian Kulim, African tiger wood, masserand duba, African kuku, and an infinite number of various combinations of stains, colors and profiles.

7. A system as defined in claim 1 engineered as a precise, consistent and continuous piece, both in width and length made to be more stable and easier to cut and apply and because it is an engineered wood product it will not crack, split, or warp like solid wood and therefore is considered a more stable foundation or core.

8. A trim system as defined in claim 1 enabled by an extremely precise cut of a wood veneer actually peeled from the tree; so this veneer gives the full visual effect and esthetic characteristics and stainable qualities of natural, “real”, or solid wood.

9. A system as defined in claim 1 that is joined, stained and finish sealed or left unsealed over a medium to high-density fiberboard or substitute selected from the group of those listed in claim 6.

10. A veneer system secured to a medium to high-density fiberboard or substitute and connected to the first layer wood veneer or substitute and recessed within and behind the first exterior “view”, layer; which provides for a superior, yet far less resource needy product.
